(19) United States
(12) Patent Application Publication
(10) Pub. No.: US 2015/0290580 A1
(43) Pub. Date: Oct. 15, 2015

(54) METHOD FOR SELECTIVE ABSORPTION OF HYDROGEN SULFIDE FROM A GASEOUS EFFLUENT COMPRISING CARBON DIOXIDE USING AN AMINE-BASED ABSORBENT SOLUTION COMPRISING A VISCOSIFYING AGENT

(71) Applicant: IFP ENERGIES NOUVELLES, Rueil-malmaison (FR)

(72) Inventors: Julien Grandjean, Lyon (FR); Laetitia Giraudon, Saint Michel Sur Rhone (FR); Bruno Defort, Paris (FR); Christine Dalmazzone, Viroflay (FR); Aurelie Mouret-Henriques, Cormeilles En Parisis (FR); Sebastien Gonnard, Grezieu La Varenne (FR)

(21) Appl. No.: 14/432,236

(22) PCT Filed: Sep. 12, 2013
(86) PCT No.: PCT/FR2013/052100

§ 371 Date: Mar. 30, 2015

(30) Foreign Application Priority Data
Oct. 5, 2012 (FR) 1202680

(51) Int. Cl. B01D 53/52; B01D 53/14

(52) U.S. Cl. CPC B01D 53/52; B01D 53/1468; B01D 53/1493; B01D 2251/80; B01D 2257/304; B01D 2256/22; B01D 2252/2021; B01D 2252/2056

(57) ABSTRACT

The invention is a method for selectively removing hydrogen sulfide H₂S from a gaseous effluent comprising at least H₂S and CO₂. A stage of selective absorption of the hydrogen sulfide in relation to the CO₂ is carried out by contacting the effluent with a solution comprising (a) water and (b) at least one nitrogen compound. The compound comprises at least one tertiary amine function or one hindered secondary amine function. The absorption selectivity is controlled by adding (c) a viscosifying compound to the absorbent solution.

### CROSS REFERENCE TO RELATED APPLICATIONS

Reference is made to French Application Serial No. 12/02.680, filed Oct. 15, 2012 and PCT/FR2013/052100, filed Sep. 12, 2013, which applications is incorporated herein by reference in their entirety.

### BACKGROUND OF THE INVENTION

1. Field of the Invention

The present invention relates to gaseous effluent deacidizing methods which are advantageously applied for treating gas of industrial origin and natural gas.

2. Description of the Prior Art

Absorption methods using an aqueous amine solution are commonly used for removing acid compounds, notably CO₂, H₂S, COS, CS₂, SO₂ and mercaptans, present in a gas. The gas is deacidized by contacting with the absorbent solution in an absorption column (absorber), then the absorbent solution is thermally regenerated in a regeneration column (regenerator). A gas depleted of acid compounds is then produced in the absorber and a gas rich in acid compounds leaves the regenerator. For example, U.S. Pat. No. 6,852,144 describes a method of removing acid compounds from hydrocarbons. The method uses a water-N-methyldiethanolamine or water-triethanolamine absorbent solution containing a high proportion of a compound belonging to the following group of piperazine and/or methylpiperazine and/or morpholine.

One limitation of the absorbent solutions commonly used in deacidizing applications is their insufficient hydrogen sulfide (H₂S) absorption selectivity in relation to carbon dioxide (CO₂). Indeed, in some natural gas deacidizing cases, selective H₂S removal is sought by limiting to the maximum CO₂ absorption. This constraint is particularly important for gases to be treated having a CO₂ content that is already less than or equal to the desired specification. A maximum H₂S absorption capacity is then sought with a maximum H₂S absorption selectivity in relation to CO₂. This selectivity allows recovery of an acid gas at the regenerator outlet having the highest H₂S concentration possible, which limits the size of the sulfur chain units downstream from the treatment and guarantees better operation. In some cases, an H₂S enrichment unit is necessary for concentrating the acid gas in H₂S. In this case, the most selective absorbent solution possible is also sought. Tail gas treatment units also require selective removal of the H₂S that is sent upstream from the sulfur chain.

It is well known in the art that tertiary amines or secondary amines with severe steric hindrance have slower CO₂ capture kinetics than primary amines or weakly hindered secondary amines. On the other hand, tertiary amines or secondary amines with severe steric hindrance have instantaneous H₂S capture kinetics, which allows selective H₂S removal based on distinct kinetic performances.

In 1950, Frazier and Kohl (Ind. and Eng. Chem., 42, 2288) notably showed that the tertiary amine N-methyldiethanolamine (MDEA) has a high H₂S absorption selectivity degree in relation to CO₂ due to the distinct kinetic performances of this amine on these two gases. However, there are cases where using MDEA does not allow the desired H₂S absorption capacity to be reached and involves insufficient selectivity. Thus, using MDEA for treating gases with high CO₂ and H₂S partial pressures, as it is for example the case for some natural gases, is of limited interest. This also applies when it is desired to reduce H₂S contents at low partial pressures, for example when treating refinery tail gas or syngas.

U.S. Pat. Nos. 4,405,581, 4,405,582 and 4,405,583 disclose the use of absorbent solutions based on hindered secondary amines for selective removal of H₂S in the presence of CO₂. U.S. Pat. No. 4,405,811 discloses the use of hindered tertiary amino ether alcohols and U.S. Pat. No. 4,483,833 discloses the use of heterocyclic aminoalcohol and amino ether alcohols for removing H₂S from a gaseous mixture comprising H₂S and CO₂. All these patents describe improved performances in terms of selectivity and capacity in relation to N-methyldiethanolamine. These amines exhibit a significant advantage in relation to MDEA for applications using gases with low acid gas partial pressures. Using these hindered amines however remains limited for higher acid gas pressures, as it is the case in most natural gas treatment applications. The absorption capacity gains can be reduced when the acid gas partial pressure increases, all the more so as temperature control in the absorber requires a limited acid gas loading in the absorber bottom. Finally, the size of the natural gas treating units using several hundred tons of amines often makes the use of solvent based on such complex amines very costly.

It is also well known in the art that partial neutralization of an MDEA solution by addition of a small amount of phosphoric acid, sulfuric acid, or other acids or ammonium salts allows reduction of the energy consumption in the reboiler for regeneration of the amine solution, or to reach lower H₂S contents in the treated gas by lowering the acid compound loading of the regenerated amine sent to the absorber top. This type of formulation is for example described in French Patent 2,313,968 B1 or in EP patent application 134,948 A2. EP-134,948 A2 indicates that this type of formulation allows reduction of the number of trays in the absorber for a given H₂S absorption specification. This reduction allows limiting the absorption of CO₂ and therefore improving the selectivity. However, no quantification of this improvement is given. Besides, protonation of the amine by an acid, as described in EP-134,948 A2 for example, can have a negative effect in the upper part of the absorber where the approach to equilibrium is critical, which may in some cases lead to the opposite effect and cause the number of trays or the circulating solvent flow rate to be increased (van den Brand et al, Sulphur 2002, 27-30 Oct. 2002).

It is also known that using an organic solvent in admixture with a tertiary amine or a hindered secondary amine, likely to contain water, allows improvement of the H₂S absorption selectivity in relation to CO₂, as described for example in French patent application 2,485,945 or in the presentations of the Sulfinol process (Huffmaster and Nasir, Proceedings of the 74^{th} GPA Annual Convention, Gas Treating and Sulfur Recovery, 1995, 133). Using the organic solvent at concentrations typically ranging between 2% and 50% as disclosed in U.S. Pat. No. 4,085,192 or between 20% and 50% in French patent application 2,485,945, provides a selectivity improvement in the case of high acid gas pressures. This advantage is however counterbalanced by a higher hydrocarbon co-absorption. For low acid gas pressures where the amount of organic solvent needs to be reduced to keep a high capture level, the selectivity gain is also reduced.

The applicant has shown that adding certain organic compounds, notably in very low proportions, to a formulation containing water and at least one tertiary or hindered secondary amine allows controlling the absorption selectivity upon selective H₂S absorption in relation to CO₂ from a gaseous effluent comprising H₂S and CO₂. The organic compound, by increasing the dynamic viscosity of the aqueous solution in a controlled manner, allows improvement of the H₂S absorption selectivity in relation to CO₂. Such a compound is referred to as “viscosifying compound” in the present description.

### SUMMARY OF THE INVENTION

The invention is a method of selectively removing hydrogen sulfide contained in a gaseous effluent comprising CO₂. A stage of selective absorption of the hydrogen sulfide in relation to the CO₂ is carried out by contacting the effluent with a solution comprising (a) water and (b) at least one nitrogen compound. The compound comprising at least one tertiary amine function or one hindered secondary amine function, and wherein the absorption selectivity is controlled by adding a viscosifying compound (c) to the absorbent solution.

The absorption selectivity can be controlled by adding less than 20% by weight of absorbent solution, preferably less than 5 wt. %, more preferably less than 1 wt. % and still more preferably less than 0.3 wt. % of a viscosifying compound to the absorbent solution to increase the dynamic viscosity of the absorbent solution by at least 25%, preferably at least 50% and more preferably at least 80%, in relation to the same absorbent solution without the viscosifying compound.

According to the invention, the viscosifying compound can be selected from the group consisting of:
polyols and their copolymers,
polyethers and their copolymers,
ethylene oxide copolymers terminated with hydrophobic motifs attached to the ethylene oxide groups by urethane groups,
partly or totally hydrolyzed polyacrylamides and their copolymers,
polymers or copolymers comprising monomer units of acrylic, methacrylic, acrylamide, acrylonitrile, N-vinylpyridine, N-vinylpyrrolidinone, N-vinylimidazole type,
linear, substituted or branched linear polysaccharides,
and their mixtures.

According to one embodiment, the viscosifying compound is polyacrylamide, partly hydrolyzed or modified by a hydrophobic motif.

According to another embodiment, the viscosifying compound is a partly hydrolyzed polyvinylic alcohol or polyvinyl acetate.

According to yet another embodiment, the viscosifying compound is a polyethylene glycol.

According to the invention, the nitrogen compound can be selected from the group consisting of:
methyldiethanolamine,
triethanolamine,
diethylmonoethanolamine,
dimethylmonoethanolamine,
ethyldiethanolamine.

The absorbent solution can comprise between 10 and 90 wt. % of the at least one nitrogen compound (b), between 10 and 90 wt. % water (a), and between 0.01 and 20 wt. % of viscosifying compound (c).

The absorbent solution can also comprise a physical solvent selected from among methanol and sulfolane.

According to the invention, the selective absorption stage can be carried out at a pressure ranging between 1 bar and 120 bars, and at a temperature ranging between 20° C. and 100° C.

After the absorption stage, a gaseous effluent depleted of acid compounds and an absorbent solution enriched in acid compounds can be obtained, and at least one stage of regenerating the absorbent solution laden with acid compounds is performed.

The regeneration stage can be carried out at a pressure ranging between 1 bar and 10 bars, and at a temperature ranging between 100° C. and 180° C.

The gaseous effluent can be selected from among natural gas, syngas, combustion fumes, refinery gas, acid gas from an amine unit, Claus tail gas, biomass fermentation gas, cement plant gas and incinerator fumes.

According to an embodiment of the invention, the gaseous effluent is natural gas or a syngas.

### BRIEF DESCRIPTION OF THE DRAWING

Other features and advantages of the invention will be clear from reading the description hereafter, with reference to the accompanying drawing wherein:

FIG. 1 shows a block diagram of a treating method for gaseous effluents comprising acid compounds using an amine-based absorbent solution, illustrating notably the method according to the invention.

### DETAILED DESCRIPTION OF THE INVENTION

In the present description, a “tertiary amine” is understood to be any molecule comprising one or more amine functions, and all the amine functions thereof are tertiary.

In the present description, a “hindered secondary amine” is understood to be any molecule comprising one or more amine functions and whose amine functions are tertiary or hindered secondary amines, one at least being a hindered secondary amine.

“Hindrance” of the secondary amine function relates to either the presence of at least one quaternary carbon at nitrogen alpha position, or to the presence of two tertiary carbons at a and a′ position.

A quaternary carbon is defined here as a carbon atom attached to four different atoms of a hydrogen atom, and a tertiary carbon as a carbon atom attached to three different atoms of a hydrogen atom.

Method of Selective H₂S Removal from a CO₂-Containing Gaseous Effluent

The method of selective H₂S removal from a CO₂-containing gaseous effluent comprises a stage of absorption of the acid compounds H₂S and CO₂ by contacting the gaseous effluent with an absorbent solution according to the invention.

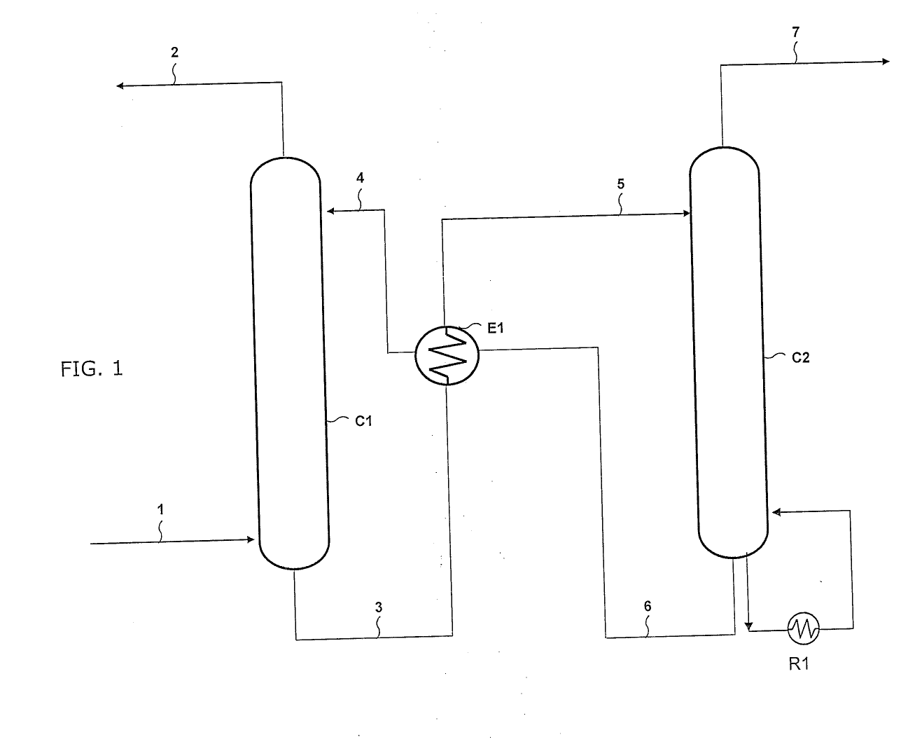

With reference to FIG. 1, the absorption stage contacts gaseous effluent 1 with absorbent solution 4. Gaseous effluent 1 is fed to the bottom of column C1 and the absorbent solution is fed to the top of C1. Column C1 is provided with gas-liquid contacting structure, for example a random packing, a stacked packing or distillation trays. Upon contacting, the amine functions of the absorbent solution, molecules react with the acid compounds contained in the effluent to obtain a gaseous effluent depleted of acid compounds 2, notably depleted of H₂S and CO₂, that leaves the top of column C1, and an absorbent solution enriched in these acid compounds 3 that leaves the bottom of column C1, preferably in order to be regenerated.

The H₂S selective absorption stage can be carried out at a pressure in absorption column C1 ranging between 1 bar and 120 bars, preferably between 20 bars and 100 bars for natural gas treatment, preferably between 1 bar and 3 bars for industrial fumes treatment, and at a temperature in absorption column C1 ranging between 20° C. and 100° C., preferably between 30° C. and 90° C., or even between 30° C. and 60° C.

The selectivity of the H₂S absorption in relation to CO₂ is controlled by adding a proportion of a viscosifying compound to the absorbent solution contacted with the gaseous effluent. The viscosifying compound according to the invention corresponds to any compound allowing an increase by at least 25%, preferably at least 50% and more preferably at least 80% the dynamic viscosity of an aqueous solution of a tertiary or hindered secondary amine, at a given amine concentration and temperature, the concentration of the viscosifying compound being less than 20% by weight of absorbent solution, preferably less than 5 wt. %, more preferably less than 1 wt. % and still more preferably less than 0.3 wt. %. A dynamic viscosity increase of at least 25% can be reached with less than 20 wt. % of absorbent solution, preferably less than 5 wt. %, more preferably less than 1 wt. % and still more preferably less than 0.3 wt. %. The same applies to a dynamic viscosity increase of at least 50% and at least 80%, which can each be obtained with less than 20% by weight of absorbent solution, preferably less than 5 wt. %, more preferably less than 1 wt. % and still more preferably less than 0.3 wt. %.

The H₂S absorption selectivity can for example be controlled by adjusting the of the viscosifying compound added to the absorbent solution to obtain the desired selectivity for a given gas treated with a predetermined equipment. A process simulator can therefore be used to determine the dynamic viscosity required for the regenerated solution in order to increase the selectivity to reach, depending on the composition of the raw gas, either the CO₂ specification limit, generally 2%, or a value as close as possible to this value considering the maximum allowable viscosity limit for the process. Once determined, the viscosity of the regenerated solution can be adjusted by adding a predetermined suitable makeup of a viscosifying compound according to the invention.

Using a viscosifying compound according to the invention added to the aqueous solution comprising the tertiary or hindered secondary amines according to the invention allows obtaining a higher H₂S absorption selectivity in relation to CO₂ than the solutions of same formulation but without the viscosifying compound. The dynamic viscosity increase generated by adding the viscosifying compound according to the invention leads to a decrease in the CO₂ absorption in relation to H₂S.

The CO₂ absorption reduction, by causing a decrease in the CO₂ loading in the absorber, also allows the gas-liquid thermodynamic equilibrium to be shifted in favour of H₂S absorption. In embodiments where the H₂S absorption kinetics are weakly impacted by the liquid phase viscosity increase, on a tray column for example, it is possible to reduce the absorption column height required to reach a given H₂S specification at the absorber top. Indeed, this absorption column is conventionally sized according to the desired H₂S specification. It is possible to reduce its height if, for the same desired H₂S specification, the H₂S absorption in the column is higher. This equipment under pressure represents a large part of the investment costs of the process, which can thus be advantageously reduced.

In any case, controlled increase in the dynamic viscosity of the absorbent solution allows a notable improvement in the H₂S absorption selectivity in relation to CO₂.

The absorption stage can be followed by a stage of regeneration of the absorbent solution enriched in acid compounds, as diagrammatically shown in FIG. 1 for example.

The regeneration stage notably is heating, and optionally expanding, the absorbent solution enriched in acid compounds in order to release the acid compounds in gas form. The absorbent solution enriched in acid compounds 3 is fed into heat exchanger E1 where it is heated by stream 6 coming from regeneration column C2. Solution 5 heated at the outlet of E1 is fed into regeneration column C2.

Regeneration column C2 is equipped with gas-liquid contacting internals such as trays, random or stacked packings for example. The bottom of column C2 is provided with a reboiler RI that provides the heat required for regeneration by vaporizing a fraction of the absorbent solution. In column C2, under the effect of contacting the absorbent solution flowing in through 5 with the vapour produced by the reboiler, the acid compounds are released in gas form and are discharged at the top of C2 through line 7. Regenerated absorbent solution 6, that is depleted of acid compounds 6, is cooled in E1 and then is recycled to absorption column C1 through line 4.

The regeneration stage of the method according to the invention can be carried out by thermal regeneration, optionally complemented by one or more expansion stages.

Regeneration can be carried out at a pressure in C2 ranging between 1 and 5 bars, or even up to 10 bars, and at a temperature in C2 ranging between 100° C. and 180° C., preferably between 130° C. and 170° C. Preferably, the regeneration temperature in regeneration column C2 ranges between 155° C. and 180° C. in cases where the acid gases are intended to be reinjected. The regeneration temperature in regeneration column C2 preferably ranges between 115° C. and 130° C. in cases where the acid gas is sent to the atmosphere or to a downstream treating process such as a Claus process or a tail gas treating process.

Advantageously, the method according to the invention allows reduction of the energy requirements for regeneration of the absorbent solution insofar as the selectivity improvement reduces the proportion of CO₂ captured with the CO₂ absorption heat generally ranging between 50 and 80 kJ/mole.

Composition of the Absorbent Solution

According to the invention, the dynamic viscosity of the absorbent solution can be adjusted by adding a viscosifying compound whose concentration allows controlling the process selectivity by controlling the dynamic viscosity of the absorbent solution.

The absorbent solution according to the invention comprises:
(a) water,
(b) at least one nitrogen compound, the compound comprising one or more tertiary amine functions or hindered secondary amine functions (two tertiary carbons at nitrogen alpha position or at least one quaternary carbon at nitrogen alpha position). Non-limitative examples of tertiary amines are methyldiethanolamine, triethanolamine, diethylmonoethanolamine, dimethylmonoethanolamine, ethyldiethanolamine.
(c) one or more viscosifying compounds by which the H₂S absorption selectivity in relation to CO₂ is controlled. The viscosifying compound allows an increase by at least 25%, preferably at least 50% and more preferably at least 80% in the dynamic viscosity of an aqueous solution with at least one nitrogen compound (b) as described above, at a given amine concentration and temperature with the concentration of the viscosifying compound being less than 20% by weight of absorbent solution, preferably less than 5 wt. %, more preferably less than 1 wt. % and still more preferably less than 0.3 wt. %.

Viscosifying compounds are molecules that owe their properties to particular chemical and physico-chemical structures. These properties are due to the intrinsic chemical nature of these molecules, that is the nature and the number of the chemical functions they have, as well as their position in the molecule, and also to the stereochemical character of these molecules, for example their sizes and shapes, and notably the way they spread and join together when they are solvated.

These compounds can be monofunctional, polyfunctional, multifunctional molecules or molecule mixtures, oligomers or polymers, linear, branched or dendritic. When these additives are polymers, their molecular weight can range between several hundred Daltons and several million Daltons.

When these additives are polymers, they can be composed from a single monomer or from several different monomers.

To make up the polymers, these monomers can be distributed randomly or in blocks in the polymer chains.

The monomers that make up the polymers of the invention can carry one or more functions selected, by way of non-limitative example, from among alcohols, ethers, polyethers, acids and their salts, esters, amides, N-substituted amides, ammonium salts, amidoalkylammonium salts, phosphonium salts, amines, sulfonates, phosphonates, phosphates, carboxybetaines, sulfobetaines, phosphobetaines. The monomers can comprise linear or branched hydrocarbon chains, aromatic rings or not, heterocycles, sulfur-containing, silyl-containing or halogenated groups, notably fluorine-containing groups. The monomers can comprise groups belonging to the general carbohydrate family. The monomers can belong to the macromonomer family. The functions provided by the monomers can have the capacity to join together or to repel each other or the medium making up the solvent.

The viscosifying compounds can be selected from the group made up of the following compounds:
polyols and their copolymers, such as glycerol and its derivatives such as diglycerols and polyglycerols, polyvinylalcohols and polyvinylalcohol copolymers, and these various polymers or copolymers can be modified by hydrophobic motifs;
polyethers and their copolymers, such as polyethylene glycols, polypropylene glycols, ethylene oxide copolymers with other epoxyalkanes such as, for example, propylene oxide, and these various polymers or copolymers can be modified by hydrophobic motifs;
ethylene oxide copolymers terminated with hydrophobic motifs optionally attached to the ethylene oxide groups by urethane groups;
partly or totally hydrolyzed polyacrylamides and their copolymers, polyacrylamides modified by hydrophobic motifs, acrylamide or N-substituted acrylamide copolymers, terpolymers or multipolymers;
polymers or copolymers comprising monomer units of acrylic, methacrylic, acrylamide, acrylonitrile, N-vinylpyridine, N-vinylpyrrolidinone, N-vinylimidazole type, and these various polymers or copolymers can be modified by hydrophobic motifs. Examples of copolymers modified by hydrophobic motifs are methacrylic acid, ethylacrylate or hydrophobic macromonomer terpolymers;
linear, linear substituted or branched polysaccharides such as xanthan, galactomannanes (guar gum), scleroglucane or cellulose derivatives modified by hydrophilic or hydrophobic motifs. Examples of such derivatives are hydroxyethylcellulose modified by hydrophobic motifs, hydroxyethylcellulose modified by hydrophobic or hydrophilic motifs, hydroxypropylcellulose modified by hydrophobic motifs, ethylhydroxyethylcellulose modified by hydrophobic motifs.

The viscosifying compounds can be polyelectrolytes and have an anionic, cationic or zwitterionic character. The anionic character can be present through, for example, carboxylate, sulfonate, sulfate, phosphate or phosphonate functions associated with an inorganic or organic cation. The cationic character can for example be present through ammonium or phosphonium functions associated with an organic or inorganic anion. Polyelectrolytes with a zwitterionic character can include copolymers having positive and negative charges in monomer blocks separated from the skeleton or polymers or copolymers having zwitterionic monomers, that is carrying a positive and negative charge on the same monomer.

The viscosifying compounds can be used alone or in association with one another.

The compound examples mentioned for each family of compounds are given by way of non-limitative example and can be selected to be any other viscosifying compound (c) likely to control the H₂S absorption selectivity in relation to CO₂ by adding the compound to an aqueous solution containing at least one tertiary or hindered secondary amine.

In an embodiment of the invention, the viscosifying compound added to the absorbent solution is a polyacrylamide, partly hydrolyzed or modified by a hydrophobic motif. Preferably, less than 20% by weight of absorbent solution, preferably less than 5 wt. %, more preferably less than 1 wt. % and still more preferably less than 0.3 wt. % of the polyacrylamide partly hydrolyzed or modified by a hydrophobic motif is added to the absorbent solution.

According to another embodiment of the invention, the viscosifying compound added to the absorbent solution is a polyvinylic alcohol than can result from the partial or total hydrolysis of a polyvinyl acetate or a partly hydrolyzed polyvinyl acetate. Preferably, less than 20% by weight of absorbent solution, preferably less than 5 wt. %, more preferably less than 1 wt. % and still more preferably less than 0.3 wt % of polyvinylic alcohol is added to the absorbent solution.

According to yet another embodiment of the invention, the viscosifying compound added to the absorbent solution is a polyethylene glycol. Preferably, less than 20% by weight of absorbent solution, preferably less than 5 wt. %, more preferably less than 1 wt. % and still more preferably less than 0.3 wt. % of polyethylene glycol is added to the absorbent solution.

According to the invention, the solution can comprise:
between 10 and 90 wt. %, preferably between 20 and 60 wt. %, more preferably between 25 and 50 wt. % of one or more nitrogen compounds (b),
between 10 and 90 wt. %, preferably between 40 and 80 wt. %, more preferably between 50 and 75 wt. % water (a), and
between 0.01 and 20 wt. % viscosifying compound (c).

According to the invention, the solution can comprise a physical solvent selected from among methanol and sulfolane.

Nature of the Gaseous Effluents

The absorbent solution can be used to deacidize the following gaseous effluents: natural gas, syngas, combustion fumes, refinery gas, amine unit acid gas, Claus tail gas, biomass fermentation gas, cement plant gas and incinerator fumes. These gaseous effluents contain one or more of the following acid compounds: CO₂, H₂S, mercaptans, COS, CS₂, SO₂.

The method according to the invention can be implemented for selective removal of H₂S from a syngas. Syngas contains carbon monoxide CO, hydrogen H₂ (generally with a H₂/CO ratio of 2), water vapour (generally at saturation at the absorption stage temperature) and carbon dioxide CO₂ (of the order of 10%). The pressure generally ranges between 20 and 30 bars, but it can reach up to 70 bars. It also comprises sulfur-containing (H₂S, COS, etc.), nitrogen-containing (NH₃, HCN) and halogenated impurities.

The method according to the invention can be implemented for selective removal of H₂S from a natural gas. Natural gas predominantly consists of gaseous hydrocarbons, but it can contain some of the following acid compounds: CO₂, H₂S, mercaptans, COS and CS₂. The proportion of these acid compounds is very variable and it can reach up to 40% for CO₂ and H₂S. The temperature of the natural gas can range between 20° C. and 100° C. The pressure of the natural gas to be treated can range between 10 and 120 bars. The invention can be implemented to reach specifications generally imposed on the deacidized gas, that is 2% CO₂ in case of a selective application, 4 ppm H₂S, and 10 to 50 ppmv of total sulfur.

### EXAMPLES

### Example 1

### Packed Absorber Calculation

The absorption stage of the method according to the invention is implemented for treating a natural gas whose pressure at the absorber inlet is 71.9 bars and the temperature is 31.2° C. The molar composition at the absorber inlet is as follows: 85 mol. % methane, 4.9 mol. % ethane, 1.41% propane, 0.26% isobutane, 0.59% n-butane, 0.15% isopentane, 0.30% n-pentane and 0.14% n-hexane. The gas also contains 0.09% water, 2.53% nitrogen, 2.13% CO₂ and 2.49% H₂S. The specifications for the treated gas are 2 ppmv for H₂S and 2 mol. % for CO₂. A maximum H₂S removal selectivity in relation to CO₂ is thus required.

The raw gas at a flow rate of 19,927 kmol/h is brought into counter-current contact with an aqueous 46.8 wt. % MDEA solution circulating at a flow rate of 400 Sm³/h in a 3-m internal diameter absorber filled with a stacked packing providing an interfacial area of 232 m²/m³. The temperature of the regenerated amine solution at the absorber top is 44.6° C. The absorber is modelled by 18 real trays on each of which the acid gas flows are calculated using the double film approach. An iterative calculation allows to solve the material and thermal balances tray by tray and to calculate, for a given packing height, the acid gas concentration and temperature profiles in the absorber.

For the reference case, the H₂S and CO₂ loadings of the regenerated amine are 7·10⁻⁴ mole H₂S per mole of amine and 3·10⁻³ mole CO₂ per mole of amine respectively.

According to the prior art, the loading of the regenerated amine fed to the absorber top can be lowered by adding a salt or an acid as described notably in French Patent 2,313,968 B1. In the most favorable case of this prior art, the regeneration rates tend toward zero (Vorber at al., Gas Processors Association 27^{th} Conference, 2010, 22-24 Sep. 2010). The maximum selectivity improvement potentially provided by addition of a salt or an acid as described in the prior art is thus evaluated by taking a totally regenerated amine into account.

According to our invention, regenerated amine loadings identical to those of the reference case are maintained. The dynamic viscosity of the aqueous 46.8 wt. % MDEA solution is varied and it can be adjusted by a viscosifying agent according to the invention. Added in a very low proportion, preferably less than 1 wt. %, this additive increases the viscosity without modifying the liquid-vapour equilibria or the intrinsic reaction kinetics with CO₂. The only adjustment parameter of the calculation thus is the viscosity of the aqueous amine solution. For each real stage, the viscosity of the solution with viscosifier is calculated by multiplying the viscosity value of the reference solution (46.8 wt. % MDEA) at the tray temperature by the ratio of the viscosities at 50° C. of the viscosified solution and of the reference solution. An inversely proportional effect of the viscosity on the liquid phase diffusion coefficients and the effects of the viscosity on the transfer parameters specific to the packing are also taken into account in the calculation.

The absorber is sized by the packing height required to reach the desired specification of 2 ppmv H₂S in the treated gas. The corresponding packing height and the CO₂ concentration in the treated gas are obtained for each formulation. The H₂S absorption selectivity in relation to CO₂ is defined by the ratio of the removal efficiencies for the two gases:

$$S = \frac{{η}_{{H}_{2} S}}{{η}_{C {O}_{2}}} .$$

These removal efficiencies are respectively defined by:

$${η}_{{H}_{2} S} = 1 - \frac{{F}_{Treatedgas} \times {y}_{Treatedgas}^{{H}_{2} S}}{{F}_{Rawgas} \times {y}_{Rawgas}^{{H}_{2} S}} and {η}_{C {O}_{2}} = 1 - \frac{{F}_{Treatedgas} \times {y}_{Treatedgas}^{C {O}_{2}}}{{F}_{Rawgas} \times {y}_{Rawgas}^{C {O}_{2}}}$$

In these expressions, F designates the molar flow rate of acid gas, raw or treated; y designates the molar fraction of acid gas, H₂S or CO₂.

Table 1 hereafter compares the results obtained by calculation for the various 46.8 wt. % MDEA formulations by varying either the loading of the regenerated amine according to the prior art or the dynamic viscosity thereof by adding a viscosifying additive according to the invention.

TABLE 1

| | Loading after | | | | | | | |
|---|---|---|---|---|---|---|---|---|
| | regeneration | | μ | Yco₂ | | | Packing | Packing |
| | α_{H2S} | α_{CO2} | (50° C.) | outlet | | S | height | height |
| | (mol/mol) | (mol/mol) | (cP) | vol % | S* | Gain | (m) | difference |
| 1—Reference | 7E−04 | 3E−03 | 3.17 | 1.58 | 3.6 | ref. | 5.00 | ref. |
| 2—Maximum | 0E+00 | 0E+00 | 3.17 | 1.61 | 3.7 | 4% | 4.80 | −4% |
| regeneration | | | | | | | | |
| according | | | | | | | | |
| to the prior | | | | | | | | |
| art | | | | | | | | |
| 3—Method | 7E−04 | 3E−03 | 4 | 1.65 | 4 | 12% | 5.05 | 1% |
| according to | | | | | | | | |
| the | | | | | | | | |
| invention | | | | | | | | |
| 4—Method | 7E−04 | 3E−03 | 6 | 1.73 | 4.7 | 33% | 5.25 | 5% |
| according to | | | | | | | | |
| the | | | | | | | | |
| invention | | | | | | | | |
| 5—Method | 7E−04 | 3E−03 | 8 | 1.78 | 5.2 | 47% | 5.50 | 10% |
| according to | | | | | | | | |
| the | | | | | | | | |
| invention | | | | | | | | |
| 6—Method | 7E−04 | 3E−03 | 10 | 1.81 | 5.7 | 60% | 5.75 | 15% |
| according to | | | | | | | | |
| the | | | | | | | | |
| invention | | | | | | | | |
| 7—Method | 7E−04 | 3E−03 | 12 | 1.83 | 6 | 69% | 6.00 | 20% |
| according to | | | | | | | | |
| the | | | | | | | | |
| invention | | | | | | | | |

*S = Selectivity

This example illustrates the selectivity gain obtained by increasing the viscosity of the 46.8 wt. % MDEA reference formulation (3.17 cP at 50° C.). It illustrates the method according to the invention, wherein selectivity is controlled by adding a viscosifying compound whose concentration allows the viscosity to be adjusted.

Thus, addition of a viscosifying compound according to the invention allows an increase by at least 25% (4 cP at 50° C.) the value of the dynamic viscosity which allows, in this example, an increase in the selectivity by at least 12%.

Through addition of a viscosifier allowing increase by 89% in the dynamic viscosity of the absorbent solution, that is at least 80% (6 cP at 50° C.), the selectivity is increased by 33%.

The highest viscosity in this example (12 cP) allows an increase in the selectivity value by 69%. In any case, the H₂S removal selectivity in relation to CO₂ of a 46.8 wt. % MDEA formulation with a viscosifying compound according to the invention is higher than the same formulation without the viscosifying compound whose regeneration would be maximized, as illustrated by the second entry in Table 1. Indeed, such a formulation with loadings after regeneration tending toward zero, which could be obtained using for example an additive such as those described in French Patent 2,318,968 B1 or in EP Patent Application 134,948, would not allow exceeding a 1.61% CO₂ concentration in the treated gas (3.7 selectivity) compared with at least 1.65% in the case of a formulation according to the invention (selectivity above 4).

Implementing the method according to the invention described here thus allows controlling and improving the selectivity in an effective and unexpected manner in relation to the prior art.

In this example, the viscosity increase requires a packing height increase in order to achieve the required specification of 2 ppmv H₂S in the treated gas. As shown in Table 2 below, this increase in the packing height, which reaches 20% maximum for a 12 cP viscosity, however remains moderate in terms of additional investment cost for the absorption column. Thus, for the 12 cP case that generates the maximum height surplus (20%), the additional cost is 6.1% in relation to the reference case.

TABLE 2

| | | | | | Mounted | |
|---|---|---|---|---|---|---|
| | μ | | | Packing | absorber | |
| | (50° C.) | Selec- | Selectivity | height | cost | Cost |
| Case | (cP) | tivity | gain | (m) | (M [symbol] ) | difference |
| 1—Ref- | 3.17 | 3.6 | reference | 5.00 | 3.037 | reference |
| erence | | | | | | |
| 2 | 3.17 | 3.7 | 4% | 4.80 | 2.992 | −1.5% |
| 3 | 4 | 4 | 12% | 5.05 | 3.038 | 0.0% |
| 4 | 6 | 4.7 | 33% | 5.25 | 3.082 | 1.5% |
| 5 | 8 | 5.2 | 47% | 5.50 | 3.130 | 3.1% |
| 6 | 10 | 5.7 | 60% | 5.75 | 3.176 | 4.6% |
| 7 | 12 | 6 | 69% | 6.00 | 3.221 | 6.1% |

### Example 2

### Tray Absorber Calculation

The absorption stage of the method according to the invention is implemented for treating a natural gas having the same characteristics as in the previous example. The raw gas at a flow rate of 19,927 kmol/h is brought into counter-current contact with an aqueous 46.8 wt. % MDEA solution circulating at a flow rate of 400 Sm³/h in a 3.5-m internal diameter absorber equipped with 4-pass valve trays, with a 60-cm tray spacing. The temperature of the regenerated amine solution at the absorber top is 44.6° C. The absorber is modelled by n real trays, by taking rigorously account of the tray geometry, on each of which the acid gas flows are calculated using the double film approach. An iterative calculation allows solving the material and thermal balances tray by tray and calculating, according to the number n of trays, the acid gas concentration and temperature profiles in the absorber.

For the reference case, the H₂S and CO₂ loadings of the regenerated amine are 7·10⁻⁴ mole H₂S per mole of amine and 3·10⁻³ mole CO₂ per mole of amine respectively.

According to the prior art, the loading of the regenerated amine fed to the absorber top can be lowered by adding a salt or an acid as described notably in French Patent 2,313,968 B1. In the most favourable case of this prior art, the regeneration rates tend toward zero (Vorber at al., Gas Processors Association 27^{th} Conference, 2010, 22-24 Sep. 2010). The maximum selectivity improvement potentially provided by addition of a salt or an acid as described in the prior art is thus evaluated by taking a totally regenerated amine into account.

According to our invention, regenerated amine loadings identical to those of the reference case are maintained. The dynamic viscosity of the aqueous 46.8 wt. % MDEA solution is varied and it can be adjusted by a viscosifying agent according to the invention. Added in a very low proportion, preferably less than 1 wt. %, this additive increases the viscosity without modifying the liquid-vapour equilibria or the intrinsic reaction kinetics with CO₂. The only adjustment parameter of the calculation thus is the viscosity of the aqueous amine solution. For each real stage, the viscosity of the solution with viscosifier is calculated by multiplying the viscosity value of the reference solution (46.8 wt. % MDEA) at the tray temperature by the ratio of the viscosities at 50° C. of the viscosified solution and of the reference solution. An inversely proportional effect of the viscosity on the liquid phase diffusion coefficients and the effects of the viscosity on the transfer parameters specific to the tray type used are also taken into account in the calculation.

The absorber is sized by the number of trays required to reach the desired specification of 2 ppmv H₂S in the treated gas. This number n of trays and the corresponding CO₂ concentration in the treated gas are obtained for each formulation. The H₂S absorption selectivity in relation to CO₂ is defined as in the previous example.

Table 3 hereafter compares the results obtained by calculation for the various 46.8 wt. % MDEA formulations by varying either the loading of the regenerated amine or the dynamic viscosity thereof by adding a viscosifying additive according to the invention.

TABLE 3

| | Loading after | | | | | |
|---|---|---|---|---|---|---|
| | regeneration | | | Yco₂ | | |
| | α_{H2S} | α_{CO2} | μ (50° C.) | outlet | | Height |
| | (mol/mol) | (mol/mol) | (CP) | vol. % | Selectivity | difference |
| 1—Reference | 7E-04 | 3E-03 | 3.17 | 1.20 | 2.19 | ref. |
| 2—Maximum | 0E+00 | 0E+00 | 3.17 | 1.25 | 2.29 | 5% |
| regeneration | | | | | | |
| according to | | | | | | |
| the prior art | | | | | | |
| 3—Method | 7E-04 | 3E-03 | 4 | 1.26 | 2.34 | 7% |
| according to | | | | | | |
| the invention | | | | | | |
| 4—Method | 7E-04 | 3E-03 | 6 | 1.42 | 2.80 | 28% |
| according to | | | | | | |
| the invention | | | | | | |
| 5—Method | 7E-04 | 3E-03 | 8 | 1.53 | 3.26 | 49% |
| according to | | | | | | |
| the invention | | | | | | |
| 6—Method | 7E-04 | 3E-03 | 10 | 1.58 | 3.52 | 61% |
| according to | | | | | | |
| the invention | | | | | | |
| 7—Method | 7E-04 | 3E-03 | 12 | 1.65 | 4.01 | 83% |
| according to | | | | | | |
| the invention | | | | | | |

This example illustrates the selectivity gain obtained by increasing the viscosity of the 46.8 wt. % MDEA reference formulation (3.17 cP at 50° C.).

It illustrates the method according to the invention, wherein selectivity is controlled by adding a viscosifying compound whose concentration allows the viscosity to be adjusted. Thus, addition of a viscosifying compound according to the invention allows increasing by at least 25% (4 cP at 50° C.) the value of the dynamic viscosity allows, in this example, to increase the selectivity by at least 7%.

Through addition of a viscosifier allowing an increase by 89% (6 cP at 50° C.) the dynamic viscosity of the absorbent solution, that is at least 80%, causes selectivity to be increased by 28%.

The highest viscosity in this example (12 cP) allows increasing the selectivity value by 83%. In any case, the H₂S removal selectivity in relation to CO₂ of a 46.8 wt. % MDEA formulation with a viscosifying compound according to the invention is higher than the same formulation without this viscosifying compound, whose regeneration would be maximized, as illustrated by the second entry in Table 3. Indeed, such a formulation with loadings after regeneration tending toward zero, which could be obtained using for example an additive such as those described in French Patent 2,318,968 B1 or EP Patent 134,948, would not allow exceeding a 1.25% CO₂ concentration in the treated gas (2.29 selectivity) compared with at least 1.26% in the case of a formulation according to the invention (selectivity above 2.34).

In this example, the viscosity increase allows reducing the number of trays required to reach the desired specification of 2 ppmv H₂S in the treated gas. As illustrated in Table 4 below, this increase that would allow saving 3 trays out of 16 for a viscosity of 12 cP allows reducing the investment cost of the absorption column by over 12%.

TABLE 4

| | | | | | Mounted | |
|---|---|---|---|---|---|---|
| | μ | | | | absorber | |
| | (50° C.) | Selec- | Selectivity | Number | cost | CAPEX |
| Case | (cP) | tivity | gain | of trays | (M [symbol] ) | gain |
| 1—Ref- | 3.17 | 2.19 | reference | 16 | 4.882 | Reference |
| erence | | | | | | |
| 2 | 3.17 | 2.29 | 5% | 15 | 4.564 | 6.5% |
| 3 | 4 | 2.34 | 7% | 16 | 4.882 | 0.0% |
| 4 | 6 | 2.8 | 28% | 15 | 4.564 | 6.5% |
| 5 | 8 | 3.26 | 49% | 14 | 4.493 | 8.0% |
| 6 | 10 | 3.52 | 61% | 14 | 4.493 | 8.0% |
| 7 | 12 | 4.01 | 83% | 13 | 4.284 | 12.2% |

Implementing the method according to the invention described here thus allows controlling and improving the selectivity in an effective and unexpected manner in relation to the prior art.

Another advantage of the invention implemented in this example with a tray column lies in the reduction in the absorption column height.

### Example 3

### Dynamic Viscosity Measurements of Various Formulations According to the Invention

The dynamic viscosity of various aqueous amine solutions is measured at 40° C. using an AMVn Anton Paar type automatic viscometer operating according to the principle of Hoepler's viscometer. The viscosity is deduced from the measurement of the falling time of a ball in a 1.6 mm-diameter capillary inclined at 80°, according to the DIN 53015 and ISO 12058 standards, and from the density measurement measured on a DMA 4100 Anton Paar densimeter at 40° C.

These measurements performed at 40° C. allow highlighting the viscosifying effect of the various compounds used according to the invention, such as the impact of this viscosifying effect on selectivity as illustrated in Examples 1 and 2 comparing the effect of the dynamic viscosity of a formulation according to the invention characterized by its value at 50° C.

By way of example, the dynamic viscosity of various formulations according to the invention, containing between 45% and 47 wt. % methyldiethanolamine (MDEA) (b) and a viscosifying compound (c) according to the invention is compared with that of MDEA solutions with the same weight percent value without a viscosifying additive.

The compounds (c) indicated in Table 5 hereafter are:
diglycerol,
PEG 35000: polyethylene glycol of weight average molecular weight equal to 35,000 g/mol,
Polyacrylamide-PAA 520 kDa: acrylamide and acrylic acid copolymer containing 80% acrylamide and 20% acrylic acid in molar fraction and whose weight average molecular weight is close to 520,000 g/mol,
Polyacrylamide-PAA 20MDa: acrylamide and acrylic acid copolymer containing 80% acrylamide and 20% acrylic acid in molar fraction and whose weight average molecular weight is close to 20 million Dalton.

TABLE 5

| | | | | Viscosity | |
|---|---|---|---|---|---|
| Compound | | Compound | | at 40° C. | Viscosity |
| (b) | Wt. % | (c) | Wt. % | (mPas) | gain (%) |
| MDEA | 45.8 | — | — | 4.18 | — |
| MDEA | 45.8 | Diglycerol | 9.9 | 7.48 | 79 |
| MDEA | 46.5 | — | — | 4.33 | — |
| MDEA | 46.5 | Polyglycerol-4 | 11.1 | 8.50 | 96 |
| MDEA | 47.0 | — | — | 4.45 | — |
| MDEA | 47.0 | PEG 35 kDa | 1 | 7.10 | 60 |
| MDEA | 47.0 | Polyacrylamid- | 0.1 | 8.29 | 86 |
| | | PAA 52 kDa | | | |
| MDEA | 47.0 | Polyacrylamid- | 0.024 | 8.45 | 90 |
| | | PAA 20 MDa | | | |

This example illustrates various compounds (c) allowing increasing the viscosity of an aqueous MDEA solution by at least 50% by adding less than 20% of the compound to the formulation. This effect can be observed for concentrations lower than or equal to 1 wt. % for PEG 35000 and for a concentration lower than or equal to 0.1 wt. % for the exemplified polyacrylamides.

### Example 4

### Kinematic Viscosity Measurements of a Xanthan-Viscosified Aqueous MDEA Solution

The kinematic viscosity of various aqueous amine solutions is measured at 40° C. using a Prolabo capillary viscometer. The viscosity is deduced from the measurement of the flow time between two marks of the liquid interface. The flow time obtained via the average of two measurements is multiplied by the tube constant in order to obtain the kinematic viscosity. The dynamic viscosity is deduced therefrom by multiplying this result by the density measured with a DMA4500M Anton Paar densimeter.

These measurements performed at 40° C. allow highlighting the viscosifying effect of the various compounds used according to the invention, such as the impact of this viscosifying effect on selectivity as illustrated in Examples 1 and 2 comparing the effect of the dynamic viscosity of a formulation according to the invention characterized by its value at 50° C.

By following this procedure, we compare in Table 6 below the dynamic viscosity between a 47 wt. % aqueous MDEA solution (reference) and a solution containing 47 wt. % methyldiethanolamine and 0.1% xanthan gum (G1253 from Sigma, molecular weight of approximately 2·10⁶ according to Sato et al., Polym. J., 16(5), 423,1984) according to the invention. For the first solution, the measurement is performed on a 0.8-mm diameter tube whose constant is 0.0002696 Poise·s⁻¹·g⁻¹cm³. For the second, the measurement is performed on a 1.09-mm diameter tube whose constant is 0.000960 Poise·s⁻¹·g⁻¹cm³.

TABLE 6

| | | | | Viscosity | |
|---|---|---|---|---|---|
| Compound | | Compound | | at 40° C. | Viscosity |
| (b) | wt. % | (c) | wt. % | (mPas) | gain (%) |
| MDEA | 47.0 | — | — | 5 | — |
| MDEA | 47.0 | xanthan | 0.1 | 20 | 300 |

This example illustrates that the addition of xanthan according to the invention allows increasing the viscosity of an aqueous MDEA solution by over 80% by adding less than 1% of said compound to the formulation.

### Example 5

### Measurement of the H₂S Removal Capacity and Selectivity from a Gaseous Effluent Containing H₂S and CO₂ by a Polyethylene Glycol-Containing Aqueous MDEA Solution

In this example, the H₂S removal capacity is measured and selectivity from a gaseous effluent containing H₂S and CO₂ by a 47 wt. % aqueous MDEA solution and by a 47 wt. % aqueous MDEA solution containing a polyethylene glycol of molecular weight 35,000 g/mol used as the viscosifying compound (see Table 7).

An absorption test is carried out at 40° C. on aqueous amine solutions in a perfectly stirred reactor open on the gas side.

For each solution, absorption is carried out in a 50 cm³ liquid volume through bubbling of a gas stream containing of a mixture of nitrogen: carbon dioxide: hydrogen sulfide in a proportion by volume of 89:10:1, at a flow rate of 30 NL/h for 90 minutes.

At the end of the test, the H₂S loadings obtained (a=number of moles of H₂S/kg of solvent) is measured, as well as the absorption selectivity in relation to CO₂.

This selectivity S is defined as follows:

$$S = \frac{{α}_{{H}_{2} S}}{{α}_{C {O}_{2}}} \times \frac{( C {O}_{2} concentration of the gas mixture )}{( {H}_{2} S concentration of the gas mixture )}$$

Under the conditions of the test described here:

$$S = 10 \times \frac{{α}_{{H}_{2} S}}{{α}_{C {O}_{2}}} .$$

By way of example, the loadings and the selectivity between a 47 wt. % methyldiethanolamine absorbent solution and an absorbent solution according to the invention containing 47 wt. % methyldiethanolamine comprising 1 wt. % polyethylene glycol of molecular weight 35,000 g/mol whose viscosity is increased by 60% in relation to the reference solution (see Example 3) can be compared.

TABLE 7

| Com- | | Com- | | Viscosity | H₂S | |
|---|---|---|---|---|---|---|
| pound | | pound | | at 40° C. | loading | H₂S/CO₂ |
| (b) | wt. % | (c) | wt. % | (mPas) | (mol/kg) | selectivity |
| MDEA | 47.0 | — | — | 4.5 | 0.16 | 6.30 |
| MDEA | 47.0 | PEG 35000 | 1.0 | 7.1 | 0.16 | 9.40 |

This example illustrates the selectivity gain that can be obtained with an absorbent solution according to the invention, comprising 47 wt. % MDEA and 1 wt. % PEG 35000, a viscosifying additive allowing the dynamic viscosity of the absorbent solution to be raised by 60%.

This example furthermore illustrates that the viscosity increase does not alter the H₂S absorption rate with the loading reached after 90 minutes being identical for the two formulations.

1-14. (canceled)

15. A method of selectively removing hydrogen sulfide contained in a gaseous effluent including CO₂, wherein a selective absorption of the hydrogen sulfide in relation to the CO₂ comprises contacting the effluent with an absorbent solution comprising (a) water and (b) at least one nitrogen compound including at least one tertiary amine function or one hindered secondary amine function and controlling the absorption selectivity by adding a viscosifying compound (c) to the absorbent solution.

16. A method as claimed in claim 15, wherein the absorption selectivity is controlled by adding less than between 20% by weight of absorbent solution of a viscosifying compound to the absorbent solution to increase the dynamic viscosity of the absorbent solution from 25% to at least 80%, in relation to the absorbent solution without the viscosifying compound.

17. A method as claimed in claim 15, wherein the absorption selectivity is controlled by adding less than 5 wt. % of a viscosifying compound to the absorbent solution, to increase the dynamic viscosity of the absorbent solution from 25% to at least 80%, in relation to the absorbent solution without the viscosifying compound.

18. A method as claimed in claim 15, wherein the absorption selectivity is controlled by adding less than 1 wt. % of a viscosifying compound to the absorbent solution to increase the dynamic viscosity of the absorbent solution from 25% to at least 80%, in relation to the absorbent solution without the viscosifying compound.

19. A method as claimed in claim 15, wherein the absorption selectivity is controlled by adding less than 0.3 wt. % of a viscosifying compound to the absorbent solution, to increase the dynamic viscosity of the absorbent solution from 25% to at least 80%, in relation to the absorbent solution without the viscosifying compound.

20. A method as claimed in claim 15, wherein the viscosifying compound is selected from the group consisting of:
polyols and their copolymers,
polyethers and their copolymers,
ethylene oxide copolymers terminated with hydrophobic motifs attached to the ethylene oxide groups by urethane groups,
partly or totally hydrolyzed polyacrylamides and their copolymers,
polymers or copolymers comprising monomer units of acrylic, methacrylic, acrylamide, acrylonitrile, N-vinylpyridine, N-vinylpyrrolidinone, N-vinylimidazole type,
linear, substituted or branched linear polysaccharides,
and their mixtures.

21. A method as claimed in claim 19, wherein the viscosifying compound is selected from the group consisting of:
polyols and their copolymers,
polyethers and their copolymers,
ethylene oxide copolymers terminated with hydrophobic motifs attached to the ethylene oxide groups by urethane groups,
partly or totally hydrolyzed polyacrylamides and their copolymers,
polymers or copolymers comprising monomer units of acrylic, methacrylic, acrylamide, acrylonitrile, N-vinylpyridine, N-vinylpyrrolidinone, N-vinylimidazole type,
linear, substituted or branched linear polysaccharides,
and their mixtures.

22. A method as claimed in claim 15, wherein the viscosifying compound is a polyacrylamide which is partly hydrolyzed or modified by a hydrophobic motif.

23. A method as claimed in claim 16, wherein the viscosifying compound is a polyacrylamide which is partly hydrolyzed or modified by a hydrophobic motif.

24. A method as claimed in claim 17, wherein the viscosifying compound is a polyacrylamide which is partly hydrolyzed or modified by a hydrophobic motif.

25. A method as claimed in claim 18, wherein the viscosifying compound is a polyacrylamide which is partly hydrolyzed or modified by a hydrophobic motif.

26. A method as claimed in claim 19, wherein the viscosifying compound is a polyacrylamide which is partly hydrolyzed or modified by a hydrophobic motif.

27. A method as claimed in claim 20, wherein the viscosifying compound is a polyacrylamide which is partly hydrolyzed or modified by a hydrophobic motif.

28. A method as claimed in claim 15, wherein the viscosifying compound is a partly hydrolyzed polyvinylic alcohol or polyvinyl acetate.

29. A method as claimed in claim 16, wherein the viscosifying compound is a partly hydrolyzed polyvinylic alcohol or polyvinyl acetate.

30. A method as claimed in claim 17, wherein the viscosifying compound is a partly hydrolyzed polyvinylic alcohol or polyvinyl acetate.

31. A method as claimed in claim 19, wherein the viscosifying compound is a partly hydrolyzed polyvinylic alcohol or polyvinyl acetate.

32. A method as claimed in claim 20, wherein the viscosifying compound is a partly hydrolyzed polyvinylic alcohol or polyvinyl acetate.

33. A method as claimed in claim 21, wherein the viscosifying compound is a partly hydrolyzed polyvinylic alcohol or polyvinyl acetate.

34. A method as claimed in claim 15, wherein the viscosifying compound is a polyethylene glycol.

35. A method as claimed in claim 16, wherein the viscosifying compound is a polyethylene glycol.

36. A method as claimed in claim 17, wherein the viscosifying compound is a polyethylene glycol.

37. A method as claimed in claim 19, wherein the viscosifying compound is a polyethylene glycol.

38. A method as claimed in claim 20, wherein the viscosifying compound is a polyethylene glycol.

39. A method as claimed in claim 21, wherein the viscosifying compound is a polyethylene glycol.

40. A method as claimed in claim 15, wherein the nitrogen compound is selected from the group consisting of:
methyldiethanolamine,
triethanolamine,
diethylmonoethanolamine,
dimethylmonoethanolamine, and
ethyldiethanolamine.

41. A method as claimed in claim 16, wherein the nitrogen compound is selected from the group consisting of:
methyldiethanolamine,
triethanolamine,
diethylmonoethanolamine,
dimethylmonoethanolamine, and
ethyldiethanolamine.

42. A method as claimed in claim 20, wherein the nitrogen compound is selected from the group consisting of:
methyldiethanolamine,
triethanolamine,
diethylmonoethanolamine,
dimethylmonoethanolamine, and
ethyldiethanolamine.

43. A method as claimed in claim 22, wherein the nitrogen compound is selected from the group consisting of:
methyldiethanolamine,
triethanolamine,
diethylmonoethanolamine,
dimethylmonoethanolamine, and
ethyldiethanolamine.

44. A method as claimed in claim 28, wherein the nitrogen compound is selected from the group consisting of:
methyldiethanolamine,
triethanolamine,
diethylmonoethanolamine,
dimethylmonoethanolamine, and
ethyldiethanolamine.

45. A method as claimed in claim 15, wherein the absorbent solution comprises between 10 and 90 wt. % of the at least one nitrogen compound (b), between 10 and 90 wt. % water (a), and between 0.01 and 20 wt. % of viscosifying compound (c).

46. A method as claimed in claim 16, wherein the absorbent solution comprises between 10 and 90 wt. % of the at least one nitrogen compound (b), between 10 and 90 wt. % water (a), and between 0.01 and 20 wt. % of viscosifying compound (c).

47. A method as claimed in claim 20, wherein the absorbent solution comprises between 10 and 90 wt. % of the at least one nitrogen compound (b), between 10 and 90 wt. % water (a), and between 0.01 and 20 wt. % of viscosifying compound (c).

48. A method as claimed in claim 22, wherein the absorbent solution comprises between 10 and 90 wt. % of the at least one nitrogen compound (b), between 10 and 90 wt. % water (a), and between 0.01 and 20 wt. % of viscosifying compound (c).

49. A method as claimed in claim 28, wherein the absorbent solution comprises between 10 and 90 wt. % of the at least one nitrogen compound (b), between 10 and 90 wt. % water (a), and between 0.01 and 20 wt. % of viscosifying compound (c).

50. A method as claimed in claim 40, wherein the absorbent solution comprises between 10 and 90 wt. % of the at least one nitrogen compound (b), between 10 and 90 wt. % water (a), and between 0.01 and 20 wt. % of viscosifying compound (c).

51. A method as claimed in claim 15, wherein the absorbent solution ranges also comprises a physical solvent selected from methanol and sulfolane.

52. A method as claimed in claim 15, wherein the selective absorption stage is carried out at a pressure ranging between 1 bar and 120 bars, and at a temperature ranging between 20° C. and 100° C.

53. A method as claimed in claim 15 comprising obtaining, after the absorption stage, a gaseous effluent depleted of acid compounds and an absorbent solution enriched with acid compounds, and regenerating at least one stage of the absorbent solution laden with acid compounds.

54. A method as claimed in claim 44, wherein the regenerating is carried out at a pressure ranging between 1 bar and 10 bars, and at a temperature ranging between 100° C. and 180° C.

55. A method as claimed in claim 15, wherein the gaseous effluent is selected from among natural gas, syngas, combustion fumes, refinery gas, acid gas from an amine unit, Claus tail gas, biomass fermentation gas, cement plant gas and incinerator fumes.

56. A method as claimed in claim 15, wherein the gaseous effluent is natural gas or a syngas.
